(19) United States
(12) Patent Application Publication
(10) Pub. No.: US 2017/0297648 A1
(43) Pub. Date: Oct. 19, 2017

(54) Human-Propellable Vehicle

(71) Applicant: Gower College Swansea, Swansea South Glamorgan (GB)

(72) Inventors: Calvin John Llewelyn Williams, Swansea South Glamorgan (GB); Paul Howard Davies, Ammanford Dyfed (GB)

(21) Appl. No.: 15/512,531

(22) PCT Filed: Sep. 18, 2015
(86) PCT No.: PCT/GB2015/052703

§ 371 Date: Mar. 17, 2017

(30) Foreign Application Priority Data
Sep. 19, 2014 (GB) 1416610.2

(51) Int. Cl. B62K 27/12; B62K 5/003; B62K 5/023

(52) U.S. Cl. CPC B62K 27/12; B62K 5/023; B62B 2207/00; B62K 5/003

(57) ABSTRACT

A human-propellable vehicle is described and comprises a chassis and a roller assembly mounted at or towards the rear of the chassis. The roller assembly is positioned to engage with a wheel of a second vehicle to permit the second vehicle to push the human-propellable vehicle.

### FIELD OF THE INVENTION

The present invention relates to a human-propellable vehicle. Embodiments of the present invention relate to a three or four wheeled bike which can be pushed along by a bicycle.

### BACKGROUND TO THE INVENTION

Four wheel gravity propelled downhill bikes are primarily aimed at disabled users. When such a bike is not rolling down a gradient, a secondary method of propulsion is required. Typically, the secondary method of propulsion is provided by the rider “self-propelling” the bike or by a second person pushing the bike. However, self-propelling the bicycle may be unsuitable for some users and significantly increase rider fatigue, while having a second person pushing the bicycle is not always practical.

Embodiments of the present invention seek to address this problem.

### SUMMARY OF THE INVENTION

According to an aspect of the present invention, there is provided a human-propellable vehicle comprising a chassis and a roller assembly mounted at or towards the rear of the chassis, wherein the roller assembly is positioned to engage with a wheel of a second vehicle to permit the second vehicle to push the human-propellable vehicle.

In this way, the problem that the front-most part (the front wheel) of a second vehicle (preferably a bicycle) cannot push against the human-propellable vehicle due to rotation of the front wheel is addressed, making it easy for the rider of the bicycle to assist with propulsion of the human-propellable vehicle when required simply by riding up behind it, manoeuvring the bicycle so that the front wheel is engaged with the roller assembly, and pedalling to push along the human-propellable vehicle while maintaining contact via the rollers.

The roller assembly comprises one or more rollers. Preferably, the roller assembly comprises upper and lower rollers at different heights. Each roller is preferably mounted with its axis of rotation substantially horizontal and substantially perpendicular to the longitudinal axis of the human-propellable vehicle.

Preferably, the roller assembly is movably mounted to the chassis to damp shock impulses transmitted to the human-propellable vehicle by the wheel of the second vehicle. The roller assembly may be mounted to the human-propellable vehicle by a first mounting assembly, the first mounting assembly being arranged to permit the roller assembly to pivot about a substantially horizontal axis, the horizontal axis being perpendicular to the longitudinal axis of the vehicle. The first mounting assembly may comprise a hinge joint or a pivot joint.

The roller assembly is preferably mounted to the chassis by a second mounting assembly, the second mounting assembly comprising one or more dampers. The dampers may each comprises a spring or a resiliently compressible component. More generally, the rollers may be movably mounted so as to be displaced away from the second vehicle when a force is exerted on them by the wheel of the second vehicle.

It is advantageous if the initial engagement between the roller assembly and the wheel of the second vehicle is smooth and does not result in jolting the rider of the human-propellable vehicle. This avoids sudden unexpected physical and psychological shocks to the rider, which is particularly important in the case of disabled riders. The same applies to ongoing jolts which may occur while the roller assembly and the wheel of the second vehicle are in engagement. The arrangements mentioned generally above and in more detail below cushion the initial impact of engagement, and any ongoing jolts, between the roller assembly and the wheel of the second vehicle. Moreover, if the second vehicle starts to drift back from the human-propellable vehicle, the roller assembly will move back with it for a short distance, maintaining engagement between the human-propellable vehicle and the second vehicle. Generally, a smoother engagement between the roller assembly and the wheel of the second vehicle may be achieved if, on engagement, the rollers are displaceable away from the impact between the wheel and rollers.

It should however be understood that damping may not be required in all cases. In particular, it has been found that due to the shock absorbing qualities of a mountain bike tyre, it is not always necessary to have the rollers spring mounted.

It will be appreciated that while embodiments of the present invention are particularly beneficial for disabled riders, they can also be used by able bodied riders.

### DETAILED DESCRIPTION

The invention will now be described by way of example with reference to the following Figures in which:

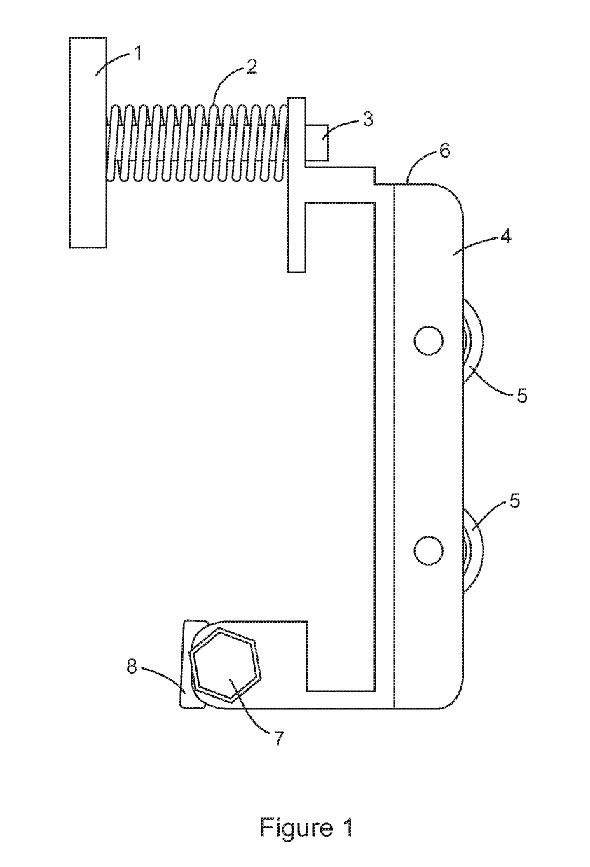

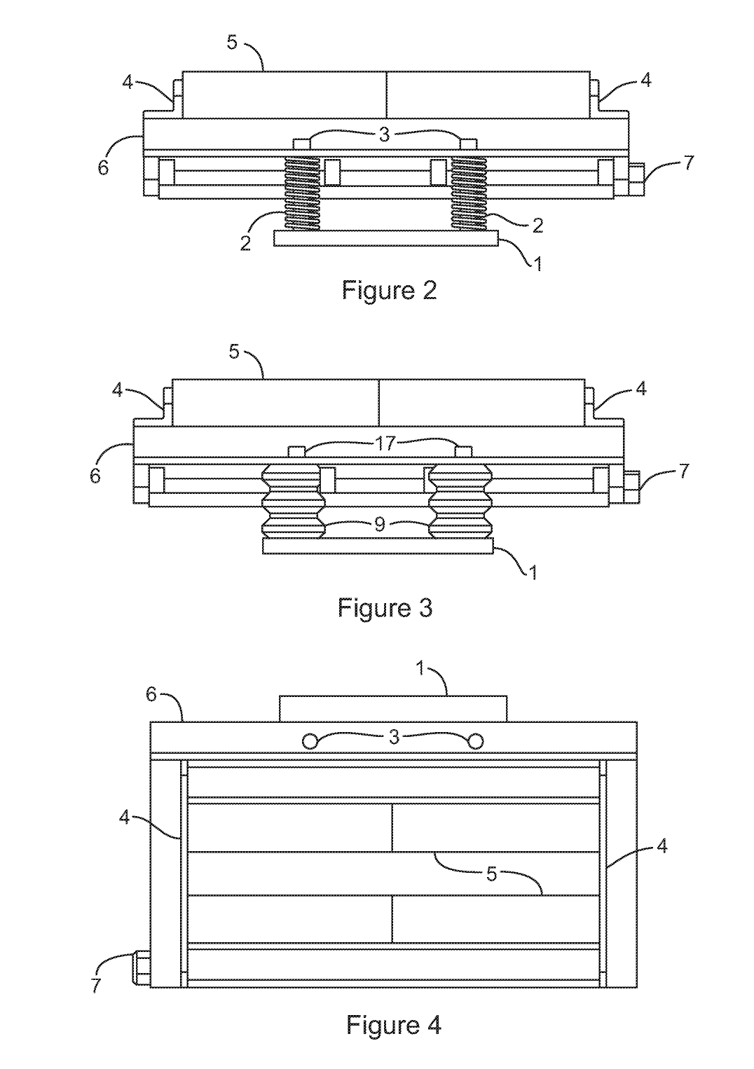

FIG. 1 schematically illustrates a side view of a roller assembly; FIG. 2 schematically illustrates a top view of the roller assembly;

FIG. 3 schematically illustrates another top view of the roller assembly;

FIG. 4 schematically illustrates a front view of the roller assembly; and

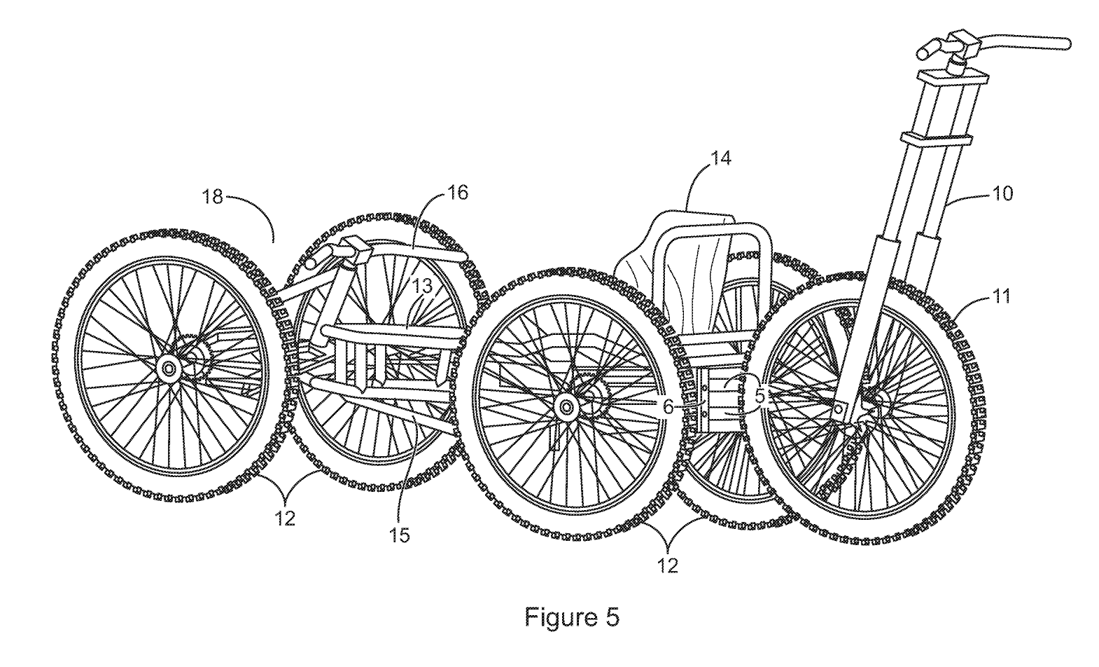

FIG. 5 schematically illustrates a 3D view of a human-propellable vehicle being pushed by a bicycle.

Referring first to FIG. 1, a side view of a roller assembly 6 is shown. The roller assembly 6 comprises a support structure 4 which carries two rollers 5, which are mounted to rotate freely about their axis of rotation (which will generally be perpendicular to the longitudinal axis of a human-propellable vehicle to which the roller assembly 6 is mounted, and substantially parallel to the ground). An upper mounting bracket 1 is provided for mounting the roller assembly 6 to a first (upper) part of the chassis of a human propellable vehicle, and a lower mounting bracket 8 is provided for mounting the roller assembly 6 to second (lower) part of the chassis of the human-propellable vehicle. The roller assembly 6 further comprises a coil spring 2 and a motion shaft/spring retainer 3, via which an upper end of the support structure 4 is attached to the upper mounting bracket 1 (and thus the chassis). The lower mounting bracket is hingedly attached to a lower end of the support structure 4 via a hinge bolt 7. The support structure 4 is therefore able to pivot about the hinge bolt 7, while the other end of the support structure 4 is permitted a limited amount of motion towards and away from the chassis by the coil spring 2 and motion shaft/spring retainer 3. In addition to permitting this motion of the roller assembly 6 towards and away from the chassis, the coil spring 2 and motion shaft/spring retainer together act as a damper/shock absorber for damping shocks applied to the support structure 4. The rollers 5 are intended to be contacted by the front wheel (and in particular the tyre of the front wheel) of a two wheeled bicycle or other second vehicle when the second vehicle is guided to push against the human-propellable vehicle to propel it along. It will be appreciated that the front wheel of a bicycle cannot normally be used to push another object due to its rotation. By providing the rollers 5 as a point of contact with the human-propellable vehicle, the rotation of the front wheel of the bicycle is not inhibited by contact with the human-propellable vehicle, but instead simply causes the rollers 5 to rotate as well.

On impact of a front wheel of a two wheeled bicycle or other second vehicle with the rollers 5 of the roller assembly, the rollers 5 are deflected towards the chassis due to a lower portion of the roller assembly 6 pivoting about an axis defined by the hinge bolt 7 and an upper portion of the roller assembly 6 being able to move along the motion shaft 3 in a direction towards the chassis. The movement is arrested and the impact is damped by the spring 2, and the spring 2 then biases the roller assembly 6 back towards its original position. It will be appreciated that the roller assembly 6 may not return fully back to its original position while a force is being exerted by the bicycle—that is, while the bicycle is pushing the human-propellable vehicle. Following the initial engagement of the front wheel of the bicycle with the rollers 5, further shock impulses may be exerted on the rollers 5 by the wheel of the bicycle, due to changes in speed, or terrain features causing the human-propellable vehicle to suddenly slow down for example. Again, these shock impulses will be damped by the spring 2.

Referring to FIG. 2, a top view of the roller assembly 6 is shown. The roller assembly 6 can be seen to comprise the upper mounting bracket 1 for mounting the roller assembly 6 to the chassis, two coil springs 2—one to each side of the upper mounting bracket 1, two motion shafts/spring retainers 3—one corresponding to each spring 2, the support structure 4 to which two upper rollers 5 are mounted side by side on a common axel (lower rollers are obscured in FIG. 2) and the hinge bolt 7.

Referring to FIG. 3, a top view of an alternative roller assembly 6 is shown, in which all components are identical to FIG. 2 (and will not be described again) except that the two coil springs 2 are replaced with two cushioning components 9 of resiliently compressible material, for example rubber, and the two motion shafts/spring retainers 3 are replaced with two motion shafts/cushioning material retainers 17. The cushioning component serves the same shock impulse damping function as the spring of FIG. 2.

Referring to FIG. 4, a front view of the roller assembly 6 is shown. The roller assembly 6 can be seen to comprise the upper mounting bracket 1 for mounting of the roller assembly 6 to the chassis, two motion shafts/spring retainers 3, a support structure 4 on which the rollers 5 are mounted, and a hinge bolt 7.

Referring to FIG. 5, a 3D view of a human-propellable vehicle 18, in this case a four wheeled bike (although a 3 wheeled bike can also be envisaged) on which the roller assembly 6 is mounted is shown. The roller assembly is positioned and orientated on the chassis to best permit engagement with the wheel of the second vehicle. The human-propellable vehicle 18 is shown to comprise four wheels 12, a seat 14, a chassis 13, a footplate 15 and handlebars 16. The roller assembly 6 is shown to be attached to a rear portion of the chassis 13 and to comprise upper and lower rollers 5. The front wheel 11 of a second vehicle 10, in this case a two wheeled bicycle is shown to be engaged with the roller assembly 6, permitting the bicycle to push the human-propellable vehicle along. It will be appreciated that the roller assembly 6 is mounted to the rear of the chassis at a suitable height for the rollers to be engaged with the front wheel of a bicycle. The use of two rollers means the different side wheels can be accommodated without moving the roller, or that the front wheel of the bicycle can engage with multiple rollers at once thereby providing a firmer engagement between the bicycle and the human-propellable vehicle. Generally, the roller assembly 6 is mounted in a substantially upright position, but this is not essential, provided that the rollers 6 are positioned such that they can be the only point of contact between the front wheel of the bicycle and the human-propellable vehicle.

1. A human-propellable vehicle comprising a chassis and a roller assembly mounted at or towards the rear of the chassis, wherein the roller assembly is positioned to engage with a wheel of a second vehicle to permit the second vehicle to push the human-propellable vehicle.

2. A human-propellable vehicle according to claim 1, wherein the second vehicle is a bicycle.

3. A human-propellable vehicle according to claim 1, wherein the roller assembly comprises one or more rollers.

4. A human-propellable vehicle according to claim 3, wherein the roller assembly comprises upper and lower rollers at different heights.

5. A human-propellable vehicle according to claim 3, wherein each roller is mounted with its axis of rotation substantially horizontal and substantially perpendicular to the longitudinal axis of the human-propellable vehicle.

6. A human-propellable vehicle according to claim 1, wherein the roller assembly is movably mounted to the chassis to damp shock impulses transmitted to the human-propellable vehicle by the wheel of the second vehicle.

7. A human-propellable vehicle according to claim 6, wherein the roller assembly is mounted to the human-propellable vehicle by a first mounting assembly, the first mounting assembly being arranged to permit the roller assembly to pivot about a substantially horizontal axis, the horizontal axis being perpendicular to the longitudinal axis of the vehicle.

8. A human-propellable vehicle according to claim 7, wherein the first mounting assembly comprises a hinge joint or a pivot joint.

9. A human-propellable vehicle according to claim 6, wherein the roller assembly is mounted to the chassis by a second mounting assembly, the second mounting assembly comprising one or more dampers.

10. A human-propellable vehicle according to claim 9, wherein the dampers each comprises a spring or a resiliently compressible component.

11. A human-propellable vehicle according to claim 1, wherein the rollers are movably mounted so as to be displaced away from the second vehicle when a force is exerted on them by the wheel of the second vehicle.

12. A human-propellable vehicle according to claim 1 comprising at least three wheels.

13. A human-propellable vehicle according to claim 12 comprising four wheels.
